(19) United States
(12) Patent Application Publication
(10) Pub. No.: US 2008/0260954 A1
(43) Pub. Date: Oct. 23, 2008

(54) Method of Binding Dry Reinforcement Fibres

(76) Inventors: Rowan Johnson Paton, Brighton (AU); Andrew Beehag, Glebe (AU)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/089,994

(22) PCT Filed: Oct. 10, 2006
(86) PCT No.: PCT/AU2006/001490

§ 371 Date: Apr. 11, 2008

(30) Foreign Application Priority Data
Oct. 11, 2005 (AU) 2005905605

(51) Int. Cl. B05D 3/02; D03D 15/00; D04H 5/06

(52) U.S. Cl. 427/385.5; 442/189; 442/409

(57) ABSTRACT

A fibre-reinforcing fabric or preform, including reinforcing fibres and semicrystalline thermoplastic polymer binder, for subsequent infusion with uncured thermosetting polymer, or a class of thermosetting polymers, and curing to make a high-performance thermoset polymer composite structure, where said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer.

### FIELD OF THE INVENTION

The present invention relates to a method of binding together fibre reinforcement materials as part of the manufacture of a thermoset polymer composite structure. In particular the invention relates to a process of selecting a thermoplastic polymer binder for its compatibility with the uncured thermosetting polymer, so that the binder does not degrade the performance of the cured thermoset polymer composite structure.

### BACKGROUND OF THE INVENTION

Continuous fibre reinforced polymer composite materials, hereafter referred to as polymer composites, are utilised for their high levels of strength and stiffness when compared to their light weight. This is principally achieved by orienting the reinforcing fibres in the principal loading directions, and varying the proportion of fibres in any one direction to gain the stiffness or strength required. In order to practically achieve this in production, the fibres come in a variety of forms, including the following: in bundles of fibres otherwise referred to as tows, which may be as small as 1 mm in diameter; in unidirectional tow sheet or tape, a wide sheet containing many tows oriented in the same direction; in a fabric, which can be a single layer that includes tows in at least one, and normally two or more, directions, assembled by a textile process such as weaving or a multi-layer fabric, where tows in various orientations on many layers are held together using a textile binder applied by a textile process such as stitching, knitting or weaving. The quality of manufactured polymer composite articles is highly dependent on the maintenance of fibre orientation, whichever form of reinforcing fibre is chosen.

Thermoset polymer composite components are manufactured using reinforcing fibres such as carbon or glass fibres and an uncured thermosetting polymer sometimes known as the matrix or resin. The uncured thermosetting polymer is normally a mixture of one or more short-chain resins and one or more hardeners, along with other materials which may include thermoplastic polymers and fillers. The uncured thermosetting polymer is combined with the reinforcing fibres and cured, often using heat, to make a thermoset polymer component.

Thermoset polymer composite components can also be manufactured using a range of processes. One subset of manufacturing methods is known as liquid moulding. In liquid moulding processes a collection of reinforcement fabrics and/or tows is shaped and compacted into a cohesive, shaped unit of reinforcing fibres called a preform. This preform can then be loaded into a mould for infusion with an uncured thermosetting polymer, sometimes referred to as the resin or matrix. The uncured thermosetting polymer is normally a mixture including one or more resin components and one or more hardener components. A key part of the preforming process is the binding system which is used to hold the reinforcement fibres together after shaping and consolidating, both to maintain shape and to tightly control fibre orientation.

The binding system, within and/or between fabrics, will be present in many of components manufactured using liquid moulding. A thermoset composite component manufactured by a liquid moulding process often has a small percentage (perhaps 1-5% by weight) of such a binding system. Generally the binding system is a polymer, or polymer powder, which is applied to the fabric and which can be softened to allow it to flow and wet the fibre tows, and then solidified to bond the fibres together. This type of binder system is referred to as an adhesive binder, or binder. The binder can be a powder, or a veil or fabric of thin polymer filaments, which must be briefly heated to partially melt it, then cooled and resolidified, attaching the binder to the fibres or fibre tows, and the different fibre tows or layers of the fabric to each other. Sometimes the binder is a solid or high-viscosity liquid which is dissolved in a solvent to allow it to be applied to the fabric by spraying.

Alternatively the binding system can be a textile binder thread, which is used to hold the layers together mechanically, and applied by weaving, stitching, tufting, knitting, or other suitable textile methods. This type of binding system is used in the manufacture of multi-axial Non-Crimp Fabrics (NCFs), in the manufacture of short fibre, or continuous fibre, mat reinforcements, in directed fibre preforming, and in the manufacture of preforms from stacks of fabric. Most conventional textile binder threads are polyester yarns, which generally have poor adhesion to epoxy resins and thus cause a weak interface between the binder and the matrix resin in the resulting laminate. The threads can also have a high level of water retention, both within the polymer and between filaments that make up the thread. The presence of water in these threads can have detrimental effects on the polymer composite matrix surrounding the fibre, and on the resulting polymer composite structure.

For optimum results, the binder system should not reduce the mechanical properties of the resulting laminate. This condition suggests that the binder system should either be present in very small amounts, or should be strongly bonded to the matrix resin. Where the binder is bonded strongly to the matrix resin, it should also have itself adequate mechanical properties for the designated application.

Currently binders may be uncured or partially-cured thermoset resins, which may become bonded to the matrix resin through adhesive bonds as the matrix resin cures or which may at least partially dissolve in the matrix resin. Alternatively they may be thermoplastic polymers. These may melt and/or dissolve in the matrix resin, or remain solid. Often the thermoplastic polymers used are amorphous thermoplastic polymers, which are easily dissolved in the matrix resin but can have poor resistance to solvents and poor mechanical properties.

Each of these types of binder causes its own problems. If the binder dissolves in the resin, there is a potential for the matrix resin to be affected, leading to reduced properties for the cured composite. These properties include the glass transition temperature (T_{g}), a measure of temperature performance of the resin, and the critical strain energy release rate (G_{C}), a measure of ability to resist fracture. If the binder does not dissolve, and also does not bond well to the matrix resin, a weak interface can be formed, which can affect the durability or strength of the composite laminate. Moreover the thermoplastic polymers, in order to ease compatibility during processing, may have low molecular weight, with resultant poor mechanical performance.

Therefore there is a need for a binding system which is both effective as an adhesive binder or textile binder, and which bonds well to the thermoset matrix resin, thereby not lowering the strength or durability of the resulting composite laminate.

The present invention alleviates the abovementioned problems, and provides a process for manufacturing a thermoset polymer composite whereby the presence of a binder in the composite structure does not substantially degrade, and may in fact enhance, the properties of the thermoset polymer composite.

### SUMMARY OF THE INVENTION

Broadly, the present invention provides a process for selecting a semi-crystalline thermoplastic polymer for holding together and aligning reinforcing fibres, tows of fibres or fabrics, for later production of a thermosetting composite structure or laminate, consisting of at least the aforementioned reinforcing material, small amounts of the aforementioned selected thermoplastic polymer binder and a larger amount of a thermosetting polymer.

In accordance with the method of the invention, selection of the thermoplastic polymer is conducted based on the solution compatibility of the aforementioned semi-crystalline thermoplastic polymer and the particular uncured thermosetting polymer, or class of thermosetting polymers, to be used as the matrix of the intended thermoset polymer composite structure, as well as other requirements for a binder polymer. Where a thermoplastic polymer and an uncured thermosetting polymer, or at least some components of an uncured thermosetting polymer mixture, have optimum levels of solution compatibility, a semi-interpenetrating polymer network (SIPN) region will be formed between the thermosetting and thermoplastic polymers if conditions are right, before the thermosetting polymer cures. Therefore if the selection of the thermoplastic binder is carried out in accordance with the method of the invention, during the infusion and cure of the composite laminate, the matrix thermosetting polymer and the binder thermoplastic polymer are able to form a controlled SIPN region between the thermoset and thermoplastic polymers.

Preferably, the selected thermoplastic binder will have mechanical performance and physical properties that do not result in the degradation of overall performance of the thermosetting polymer and the resulting thermoset composite. These properties include, but are not limited to, adequate mechanical performance of the polymer at a range of service temperatures, low levels of water retention, and high solvent resistance. Frequently, these superior properties will be found in a semi-crystalline thermoplastic.

More preferably, the thermoplastic polymer can be obtained or manufactured into a form that may be used for holding together reinforcing fibres, fibre tows or fabrics. These forms include, but are not limited to, powders, filaments, fabrics and veils.

Preferably, the reinforcing fibre material fixed according to the process of the invention will be in the form of fibre tows, chopped fibre tows, fibre mat, woven fabrics, multilayer fabrics, 3D fabrics, or a stack of fabrics or group of tows.

According to a first embodiment of the invention, there is a process provided for manufacturing a reinforcing fibre preform or fabric including a thermoplastic polymer binder, for subsequent infusion with uncured thermosetting polymer and curing to make a high-performance thermoset polymer composite structure, the process including:
selecting a semi-crystalline thermoplastic polymer as a binder for the fabric or preform and a thermosetting polymer for the thermosetting matrix of the thermoset polymer composite structure, such that said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer;
applying said semi-crystalline thermoplastic binder polymer discretely to selected regions of reinforcing fibre material;
bringing together and aligning said reinforcing fibre material and said semi-crystalline thermoplastic binder polymer into the desired spatial arrangement, shape and proximity;
heating said reinforcing fibre material and said semi-crystalline thermoplastic binder polymer to a temperature whereby said semi-crystalline thermoplastic polymer is able to flow and wet the fibres;
cooling said reinforcing fibre material and said semi-crystalline thermoplastic polymer below the flow temperature of said semi-crystalline thermoplastic polymer, thereby fixing said reinforcing fibre material into position and orientation through adhesion between said thermoplastic polymer and said reinforcing fibre material.

According to a second embodiment of the invention, there is a process provided for manufacturing a reinforcing fibre preform or fabric including a thermoplastic polymer binder, for subsequent infusion with uncured thermosetting polymer and curing to make a high-performance thermoset polymer composite structure, the process including:
selecting a semi-crystalline thermoplastic polymer as a binder for the fabric or preform and a thermosetting polymer for the thermosetting matrix of the thermoset polymer composite structure, such that said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer;
bringing together and aligning the reinforcing fibre material into the desired spatial arrangement, shape and proximity;
fixing said reinforcing fibre material in position and orientation using said semi-crystalline thermoplastic polymer in the form of one or more fibres, filaments, threads, or yarns, by combining said reinforcing fibre material and said thermoplastic binder by a textile process selected from the group consisting of stitching, weaving, tufting, braiding, weft knitting and warp knitting.

Advantageously, by selecting a semi-crystalline thermoplastic binder polymer and thermosetting polymer or class of thermosetting polymers by the process of the invention, infusion by aforementioned thermosetting polymer of a fabric or preform manufactured according to the process of the invention and subsequent cure can result in a high strength bond between said semi-crystalline thermoplastic polymer and said thermosetting polymer.

It will be understood by those skilled in the art that the reinforcement fabric or preform manufactured according to the first or second embodiments of the invention may be used in a liquid moulding process, in which the curing process normally follows soon after the infusion process. Alternatively, the reinforcement fabric or preform may be used to produce a pre-impregnated fabric, usually called a prepreg, which can be stored and later cut to the desired shapes and sizes, and assembled on a mould to produce a lay-up, which is then cured.

More advantageously, by undertaking a process of curing aforementioned selected thermosetting polymer to control or enhance the solution compatibility between said thermosetting polymer and aforementioned semi-crystalline thermoplastic, a semi-interpenetrating polymer network region may be formed between said thermosetting polymer matrix and said thermoplastic polymer binder during the curing of the thermosetting polymer matrix.

The semi-crystalline thermoplastic polymer binder used in the process of the invention may be in the form of small particles such as a powder or fibres, or as a woven or non-woven veil or fabric. The powder or veil may be used according to the process of the first embodiment of the invention to fix the position and orientation of reinforcing fibres by selectively placing said thermoplastic binder amongst aforementioned reinforcing fibres, such that raising the temperature of the combined reinforcing material and thermoplastic binder together results in the melting of the thermoplastic, allowing flow and wetting of the fibres, followed by solidification, thereby fixing the position and orientation of adjacent portions of the reinforcing fibres' structure that otherwise may experience relative movement.

Additionally the semi-crystalline thermoplastic polymer used in the process of the invention may be in the form of a filament. This filament itself may consist of a single filament, or a plurality of filaments that are combined together to act as a single filament or thread. The filament may be used according to the process of the second embodiment of the invention to fix reinforcing fibres by stitching or knitting, or other textile process, or alternatively according to the first embodiment of the invention by selectively placing said thermoplastic polymer amongst aforementioned reinforcing fibres, such that raising the temperature of the combined reinforcing material and thermoplastic polymer together results in the melting of the thermoplastic polymer, allowing flow and wetting of the fibres, followed by solidification, thereby fixing the position and orientation of adjacent portions of the reinforcing fibres' structure that otherwise may experience relative movement.

Fix, fixed or fixing, as described within the summary of the invention, is a relative term, indicating that the general axis of orientation, and the overall position of fibres and fabrics, is held within a desired margin. The process of the invention does not result in the precise alignment and position of all segments of a reinforcing fibre or fabric. Furthermore, it will be understood by those skilled in the art that the process of infusing a fabric, fabrics or combined reinforcing fibres held together with stitching, binder or an equivalent fixing system may alter the position and orientation of local areas of the reinforcing fibres. It will also be understood that an increasing amount and appropriateness of placement of stitching, binding or equivalent fixing material will improve the level of fixing of the reinforcing material.

Advantageously, the process of the invention includes an efficient preforming process and may be used with other processing steps to produce a composite structure with high resin-dominated properties due to the excellent bond between the binder and the thermoset resin.

Advantageously, additional processes may be incorporated into the stated process of the invention to ease manufacturing of the reinforced fibre preform shape. For instance, additional processes may be employed to shape the reinforcing fibre materials and selected semi-crystalline thermoplastic material while the combined materials are heated, in order to minimise fibre breakage or maximise processing efficiency. Subsequent cooling of the shaped stack will preserve the final geometry of the preform. Therefore the process of bringing together and aligning reinforcing fibre material into the desired spatial arrangement, shape and proximity, as stated in the first and second embodiments of the invention, in no way indicates that this is the final spatial arrangement, shape or proximity of the preform manufactured according to the first or second embodiments of the invention, if subsequent shaping operations are performed. Preferably, the semi-crystalline thermoplastic polymer selected according to the first or second embodiments of the invention is polyvinylidene fluoride (PVDF), either pure PVDF or containing the PVDF in combination with other polymers and/or conventional additives, or a block copolymer containing PVDF blocks or monomer units. The thermoplastic polymer may be in the form of a filament, thread, veil or powder, or other form that can be discretely distributed amongst the reinforcing fibre material.

The thermosetting polymer or class of thermosetting polymers selected according to the first or second embodiments of the invention is preferably a mixture including but not limited to one or more resin components and one or more hardener components, initially uncured and later cured at an appropriate elevated temperature. In the case of a thermosetting polymer composite, the composite is a suitable thermosetting polymer reinforced with one or more other materials. More preferably the thermosetting polymer is an epoxy or a bismaleimide, or the class of thermosetting polymers is epoxy polymers or bismaleimide polymers.

Advantageously, using either the first or second embodiments of the current invention, a reinforcing fibre product or preform can be manufactured which upon subsequent infusion with a selected compatible thermosetting polymer, and curing, will result in tightly bound matrix.

More advantageously, the process of the current invention may be used to join together reinforcing fibre products, fabrics, preforms or assemblies previously made according to the process of the current invention. In particular, one or more stitched fabrics that are formed according to the second embodiment of the invention may be joined together by distributing some selected thermoplastic material between fabrics and processing according to the first embodiment of the invention. It will also be understood that fabric stacks or equivalent reinforcing fibre preforms made according to the first embodiment of the invention may have some of the selected thermoplastic distributed through the stack or preform prior to bringing together fabric layers in accordance with the first embodiment of the invention.

Given sufficient textile binder in the fabric, additional fabrics may be joined together and shaped according to the first embodiment of the invention without further addition of thermoplastic. In particular, one or more fabrics manufactured according to the second embodiment of the invention, where sufficient binder material is present on one or more of the surfaces to be joined, may be brought together without additional thermoplastic binder, and may be processed according to the first embodiment of the invention.

A high level of solution compatibility between individual materials can be measured directly through solubility trials or, where complex systems of many components are involved, by practical measures of compatibility such as interpenetration distance i.e. the distance that one material or group of materials is able to migrate into the body of another material. The abovementioned high level of solution compatibility between thermosetting and thermoplastic polymer can be quantified in terms of interpenetration distance as being sufficient to provide significant levels of adhesion, for example between 0.1 and 100 μm.

According to a third embodiment, there is provided a fibre-reinforcing fabric or preform, including reinforcing fibres and semicrystalline thermoplastic polymer binder, for subsequent infusion with uncured thermosetting polymer and curing to make a high-performance thermoset polymer composite structure, where said semi-crystalline thermoplastic polymer and said thermosetting polymer have a high level of solution compatibility at the curing temperature of the thermosetting polymer and are able to partially interpenetrate before curing of the thermosetting polymer.

It is preferable that the semicrystalline thermoplastic polymer is able to wet the reinforcing fibre material when heated and flowable.

In a fourth embodiment, the invention provides a reinforced thermoset polymer composite structure including reinforcing fibre material and a thermoset matrix polymer, at least part of the reinforcing fibre material having previously been assembled into a fabric or preform using a semicrystalline thermoplastic binder polymer, the thermoplastic binder polymer and the cured thermoset matrix polymer having an interfacial region with a semi-interpenetrating polymer network structure.

### BRIEF DESCRIPTION OF THE DRAWINGS

The invention will now be described, by way of example only, with reference to the accompanying drawings in which:

FIG. 1a illustrates a section of a multi-axial reinforcing fibre fabric.

FIG. 1b illustrates the application of a powder form of a selected semi-crystalline thermoplastic polymer to the upper surface of the fabric as described in FIG. 1a.

FIG. 1c illustrates a stack of fabric layers as described in FIG. 1a.

FIG. 1d illustrates the application of shaping forces and heat to the fabric stack described in FIG. 1c.

FIG. 1e illustrates the fabric stack described in FIG. 1c fixed in spatial arrangement, shape and proximity.

FIG. 2a illustrates assembled internal layers of a typical non-crimp fabric consisting of tows of reinforcing fibres (some tows removed for illustration clarity).

FIG. 2b illustrates the layers of a non-crimp fabric described in FIG. 2a after stitching together with a selected semi-crystalline thermoplastic thread.

FIG. 3 illustrates a Hansen solubility diagram for a polymer which can be used to determine the solubility of a solvent for a particular polymer.

### DESCRIPTION OF PREFERRED EMBODIMENTS

In both embodiments of the invention, a semi-crystalline or crystalline thermoplastic binder is combined with fibre reinforcement to form a reinforcement fabric or reinforcement preform. After subsequent resin infusion of the fabric or preform, and during curing of the composite laminate, the semicrystalline thermoplastic binder and the thermosetting resin form a semi-interpenetrating polymer network interface, ensuring a strong bond between the thermoplastic binder and the thermosetting resin in the cured composite laminate.

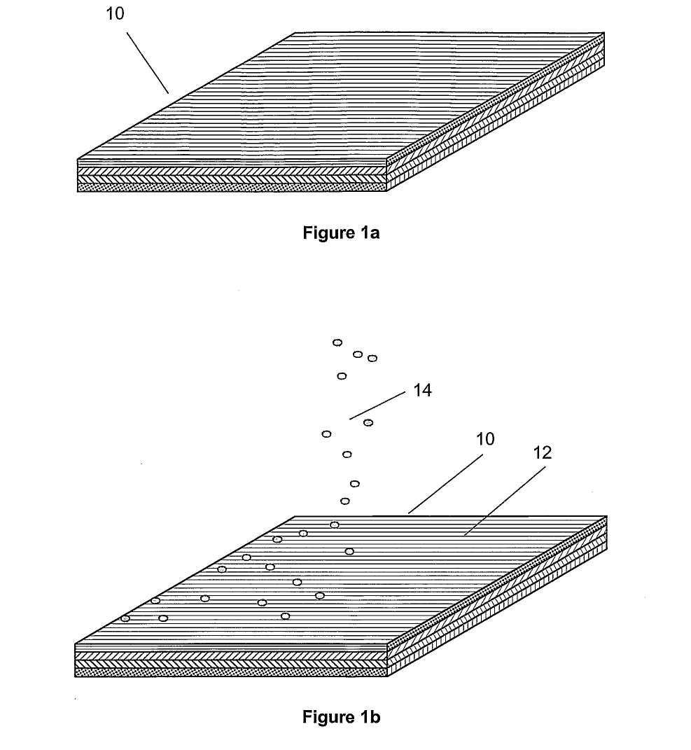

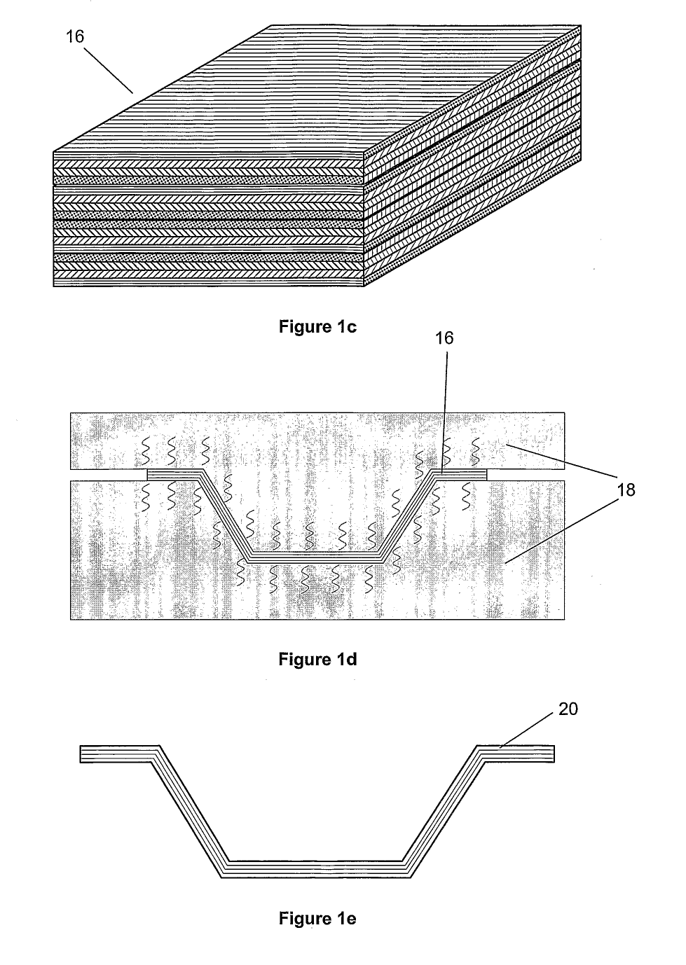

The method according to the first embodiment of the invention is suitable for use with fabrics (10) as depicted in FIG. 1a. In order to make a reinforcement preform, a plurality of such fabrics (10), which may be cut to different shapes and applied in different orientations, may be stacked in specific order, position and orientation, and maintained in that position following the process described in the first embodiment of the invention. A semi-crystalline thermoplastic polymer (14) is applied discretely to the fabric surface (12), as illustrated in FIG. 1b. The thermoplastic (14) is applied discretely in order that subsequent processes on the assembled fabric stack, such as the infusion of a liquid thermosetting resin, are not impeded by the presence of an impermeable layer of thermoplastic or other such obstructions. Likewise there is no limitation on the number of locations or surfaces that the thermoplastic may be applied to, subject to the overall constraint detailed previously that the thermoplastic not cause later unacceptable impediment to flow or other such problems. The thermoplastic (14) illustrated in FIG. 1b is a powder, however this does not limit the application of the thermoplastic to this form, and equally the thermoplastic could be in the form of a veil, web, filament, perforated sheet or any other form that can be used to locate the thermoplastic on the surface (12) of the fabric (10) at discrete intervals.

Following application of the thermoplastic (14) to the fabric (10), layers of the fabric (10) are brought together, as illustrated in FIG. 1c. In order for the method of the invention to be successful, the thermoplastic (14) would need to be applied in sufficient quantity to join each of the separate items located in the stack (16). This may be achieved by applying the thermoplastic (14) to at least one surface (12) of each inner interface between separate fabric pieces (10), or otherwise applying the thermoplastic (14) in such a way that, when later melted, the thermoplastic (14) flows and contacts a sufficient proportion of each separate piece of fabric (10). At a minimum it would be presumed that two separate points of each fabric piece (10) must be secured to the adjacent fabric piece when using a globular form of thermoplastic (14), such as a powder. However this may be insufficient for overall fabric stack (16) stability, and substantially wider dispersion of powder is likely to be necessary. An alternative is to use a continuous form of thermoplastic binder such as a veil or web, which is effectively a large perforated single region of contact.

The fabric layers (10) should be arranged such that, following the process of heating, and if necessary shaping, illustrated in FIG. 1d, the individual layers (10) are in their preferred position and orientation. Heat is applied in the current process by means of a heated tool (18), with heat transmitted through the combined fabric layers (10) and thermoplastic (14). Equally, the stack (16) could be heated by other means, for example an oven, hot air gun, or infrared lamp. The application of heat need not be after the stacking of multiple layers (10) of the fabric. In fact, some advantage may be obtained in applying heat to each layer of fabric (10) as it is placed on the stack (16) with its joining thermoplastic (12), fixing it in position to the already stacked fabric (16) prior to placing the next fabric layer (10).

The process of applying heat as illustrated in FIG. 1d also includes changing the shape of the fabric stack (16) from a flat stack to one with a changed geometry. This is not a part of the process as described in the first embodiment of the invention. However, it is practical at this stage to add shape to the fabric stack (16). The application of heat to melt the thermoplastic (14) will also allow the fabric plies (10) to slide easily relative to one another, simplifying the process of shaping. In this instance, the fabric layers (10) may be already joined to adjacent fabrics with thermoplastic (14) by heating of individual layers (10) as they are placed on the stack (16), or fabrics (10) may be able to move relative to one another.

The process of applying sufficient heat causes the thermoplastic (14) to melt, or attain such mobility that it is able to flow. The temperature selected depends on the need to obtain sufficient, but not excessive, flow in the thermoplastic, and obtaining a level of adhesion between the thermoplastic (14) and the fibres that constitute the reinforced fibre fabric (10). Too high a level of flow could reduce the dimension of the thermoplastic (14) locally where it has to act as a load carrying member, in order to transmit force between adjacent layers of a fabric. Adhesion, on the other hand, will be most likely to result from an encapsulation of individual reinforcing fibres by the thermoplastic (14), that are likewise bound securely in the fabric (10). It is also possible that there can be, with appropriate selection of a thermoplastic (14), a level of chemical attraction between the reinforcing fibres and thermoplastic, such that the thermoplastic (14) acts as a more effective adhesive.

Upon cooling of the fabric stack (16) and thermoplastic (14), the thermoplastic (14) is reduced in temperature to a point where no further flow can occur. At this point, shown schematically in FIG. 1e, the finished preform (20) is held in a set geometry, with individual constituent plies held in a fixed position and orientation relative to each other. The level of fixing of the individual plies (10) is dependent on the amount and distribution of the binding thermoplastic (12), and the quality of the heating process used to bind the separate layers together.

It will be clear to those skilled in the art that the method according to the first embodiment is also suitable for binding individual tows and even individual fibres into a reinforcing fabric, which may have only one reinforcing fibre orientation, or a shaped preform.

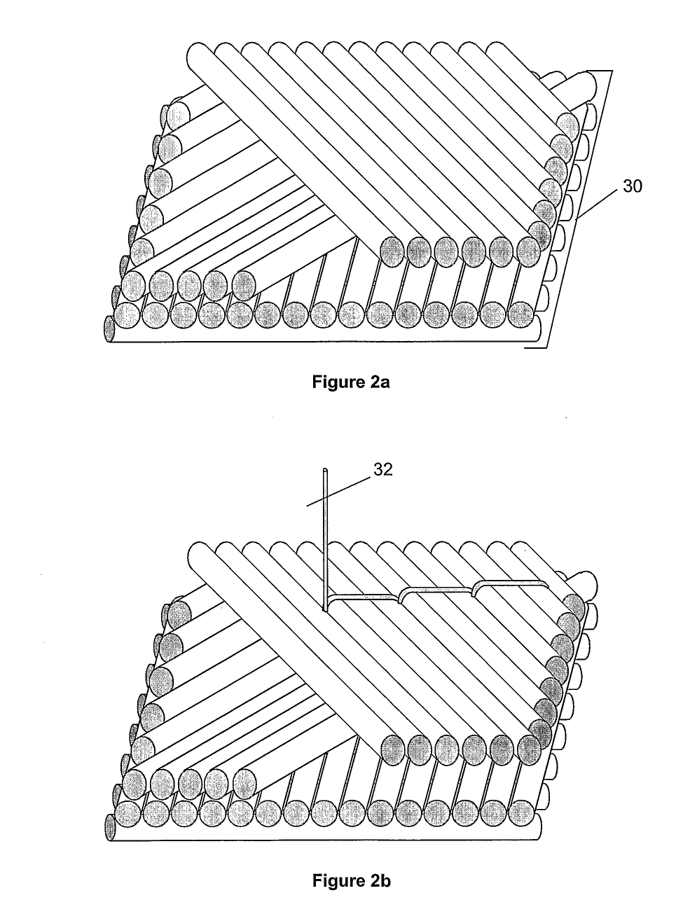

The method of the second embodiment of the invention is shown by example in FIG. 2a, where individual tows (22) in different orientations are arranged in separate layers. The process, well known in the current art, is used to produce fabrics such as multiaxial non-crimp fabrics (NCFs), which have separate, differently orientated layers of reinforcing fibres brought together and held in place by a stitching or knitting process. The tows consist of a plurality of individual reinforcing fibres, generally between 3,000 and 80,000 individual fibres, which are often lightly bound together. In accordance with currently known methods, the tows are then stitched or knitted together to form a single multilayer fabric (30) that can be trimmed, shaped and also joined to other fabrics, and will ultimately be infused with a thermosetting resin to form a continuous fibre reinforced composite.

Prior to stitching, each of the tows (22) are placed and mechanically held relative to other tows in a fixed position. This may, for example, be performed with a loom or other similar device. FIG. 2b contains a diagram of the binder yarn (32) being passed through the assembled tows. This may be practically achieved by a variety of textile methods, such as by weaving, stitching, knitting, tufting, or overlooking. The tension in the thermoplastic yarn (32) is normally sufficient to hold the tows (22) in place, but not so high as to excessively crimp the tows (22). Following the textile fixing process with the thermoplastic thread (32), the tows (22) are held in position and alignment relative to each other. In this instance, the degree of fixing is determined by the location and concentration of stitching, and the tension within the thermoplastic thread (32).

It will be clear to those skilled in the art that a reinforcing fabric (30) produced by the process described above may have only one layer of reinforcing fibres or tows (22), all aligned in the same direction. The thermoplastic polymer binder (32) in this case is binding the different tows of a unidirectional tape fabric together. Similarly the thermoplastic binder (32) may be used in technical embroidery to hold fibre tows in place as they are placed in the desired position and orientation.

It will also be clear to those skilled in the art that the examples of the first and second embodiments of the current invention may be extended, by applying the other embodiment of the invention. The fabric in the first example of the preferred embodiment, shown in FIG. 1e with individual layers joined by melting of thermoplastic, could be instead joined by stitching using the second embodiment of the invention. In this instance a stack of individual fabric layers could be placed and oriented according to a desired final geometry, held in place temporarily by mechanical means, and then fixed by stitching or an equivalent textile process according to the second embodiment of the invention. Likewise, individual tows, as shown in FIG. 2a, could be assembled together with a light coating of thermoplastic powder, or thermoplastic in an equivalent convenient form, be placed in a press or equivalent heating device, and be joined together by melting the thermoplastic between adjacent tows, in accordance with the first embodiment of the invention.

The use of a semi-crystalline thermoplastic in both the first and second embodiments of the invention requires the application of a selection criterion, based on solution compatibility between the thermoplastic and a thermosetting polymer or class of thermosetting polymers. This will be discussed below.

### Polymer Thermodynamics and Solubility Criteria

The selection of compatible polymers requires a close matching of several solubility parameters. The principle of material selection for a compatible amorphous thermoplastic is based on the Gibb's free energy of mixing (ΔGₘ), which states that

ΔGₘ=ΔHₘ−TΔSₘ≦0 (1)
where ΔHₘ is enthalpy of mixing, T is temperature and ΔSₘ is entropy of mixing. The Hildebrand-Scatchard equation can then be used to determine the enthalpy of mixing as

ΔHₘ=VΦₐΦ_{b}(δₐ−δ_{b})² (2)
where δₐ and δ_{b} are the solubility parameters (also known as the Hildebrand parameters) of the two species considered, e.g. amorphous polymer and monomer or hardener.

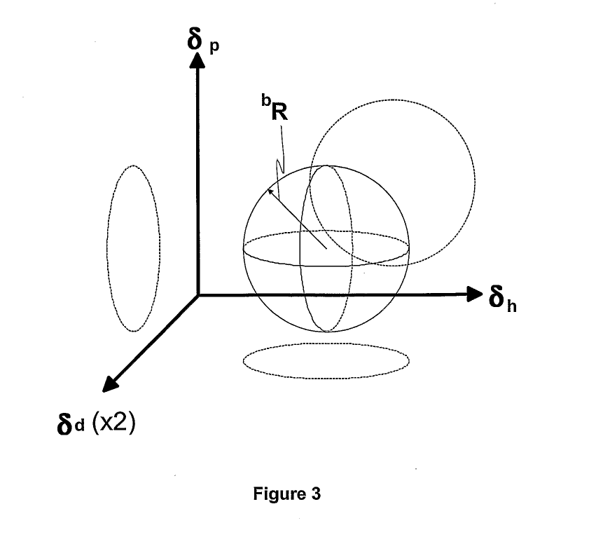

However, the use of the Hildebrand-Scatchard equation (Equation (2) above) is inadequate for the class of high-performance semi-crystalline thermoplastics that would be most favourable for joining applications, as intermolecular forces such as polar forces greatly affect the solubility behaviour of these polymers. The use of Hansen parameters which take account of dispersion, polar and hydrogen bonding forces is recommended as a more suitable approach for these polymers (See AFM Barton “CRC Handbook of Solubility Parameters and Other Cohesion Parameters”, CRC Press, Boca Raton, 1983). The application of these parameters provides a reasonable guide for polymer-solvent compatibility. A radius of compatibility for polymer b is defined by radius ^{b}R, as shown in the solubility chart in FIG. 3. The Hansen solubility parameters for dispersion (δ_{d}), polar (δₚ) and hydrogen bonding forces (δₕ) for any solvent a can be determined and plotted on the chart. Where the point on the solubility chart locating the three Hansen parameters for solvent a (^{a}δ_{d}, ^{a}δ_{d}, and ^{a}δ_{d}) lies within the sphere defined by ^{b}R, the polymer is soluble in the solvent, i.e.

[4(^{a}δ_{d}−^{b}δ_{d})²+(^{a}δₚ−^{b}δₚ)²+(^{a}δₕ−^{b}δₕ)²]^{1/2}<^{b}R (3)
where the solvent in this case is the monomer or hardener, and ^{b}R is determined by standard experiments using common solvents of known Hansen parameters.

An advantageous feature of the first and second aspects of the current invention is the alteration of the “effective solubility parameter” of the semi-crystalline thermoplastic. This is achieved by bringing the thermoplastic and selected thermosetting polymer, or member of the class of selected thermosetting polymers, to a sufficiently high temperature. In general terms, solvents cannot migrate effectively through the solid crystalline portion of polymers, due to insufficient free energy to overcome the heat of fusion of the crystalline portion of the polymer. Through increased temperature of the system, the heat of fusion is overcome. Under these circumstances the components of the uncured thermosetting polymer (monomer and hardener) are able to migrate through the polymer, whereas previously the polymer was insoluble. Hence the “effective solubility parameter” of the polymer is altered through the addition of heat.

Formation of a semi-interpenetrating polymer network requires the matching of complex solubility parameters, which are partially dependent on temperature. Through careful matching of the monomer/hardener and thermoplastic solubility properties, and at a suitable temperature, the presence of the thermoset monomer, acting as a solvent, can overcome the heat of fusion of the crystalline polymer, thus giving an “effective melting temperature” which depends on the monomer/hardener involved. This “effective melting temperature” may be a temperature where the remainder of the polymer is still solid. Under these circumstances the monomer and hardener are able to migrate through the polymer below the normal melting temperature.

It should be noted that the melting temperature or lower “effective melting temperature” described here would be a minimum processing temperature, and that standard curing conditions for the thermosetting polymer may impose a higher processing temperature.

A semi-crystalline thermoplastic polymer selected according to the above criteria may be bonded strongly, by the formation of a substantial semi-interpenetrating polymer network (SIPN) to the selected thermosetting polymer following infusion and subsequent cure. An aspect of the process is the selection of a thermosetting polymer and a thermoplastic with a solubility determined by the use of Hansen parameters, and the selection of a curing temperature/time cycle for the thermosetting polymer such that the thermosetting monomer and hardener are able to migrate to the desired extent into the semi-crystalline polymer, or into the crystalline component of the thermoplastic polymer by overcoming the heat of fusion of the crystalline component.

Following cure of the component, the thermoplastic binder is intimately bonded to the thermosetting polymer matrix through the entanglement of molecular chains in the thermoplastic/thermoset interfaces thereby forming a semi-interpenetrating polymer network between the thermosetting polymer and the thermoplastic polymer.

### EXAMPLES

### Solution Compatibility of Semi-Crystalline Thermoplastic Polymer and Thermosetting Polymer

A carbon fibre reinforced epoxy composite panel, incorporating a film of thermoplastic on the surface, was manufactured using the resin transfer moulding (RTM) process. Two plies of Saertex SQ1090 and two plies of Saertex SQ1091 carbon fibre NCF were arranged in an RTM mould, with a 0.003″ film of PVDF placed underneath the fabric stack. PVDF was selected based on its known solution compatibility with epoxy resins. The mould was closed and infused with Hexcel RTM6 resin at 80° C. Subsequently, the mould was raised to 177° C., and held at that temperature for 2 hours. Following removal of the panel from the mould, a semi-interpenetrating polymer network was found between the PVDF and the cured RTM6. The relative concentration of fluorine atoms across the interface between the thermoplastic and cured epoxy resin was measured using Energy Dispersive X-Ray Spectroscopy. An apparent interdiffusion width of 5 μm was measured at the interface between the PVDF and RTM6 resin. Similar evidence of interpenetration of cured epoxy resins and PVDF has been found in PVDF-surfaced carbon-epoxy panels made using a number of other aerospace grade epoxy resins which are recommended for cure at approximately 177° C.

Binding Reinforced Fibre Layers with Thermoplastic Powder

PVDF powder was selected as a binder for its demonstrated solution compatibility at temperature with epoxy resins, and in particular with Hexcel RTM6 epoxy resin. Fortafil 80K carbon fibre tows were brought to form a desired shape, by guiding through eyelets arranged in the shape of the die cavity. PVDF powder was then dusted through the carbon fibre tows using a brush, allowing the powder to adhere to the tows by electrostatic attraction. The tows and powder then entered the heated die, where the temperature profile of the die was established to firstly heat the tows and powder above the melt temperature of the PVDF, then subsequently cool below the melt temperature. A wedge cross-section preform and a triangular cross-section preform were successfully profiled using the above technique, with the resulting preforms having sufficient dimensional stability for handling and subsequent infusion. The wedge cross-section was subsequently infused with Hexcel RTM6 epoxy resin, and cured at 180° C. and 100 kPa for 2 hours. When cross-sectioned and examined, the cured component showed evidence of good wet-out of the product, and good combination of the RTM6 resin with the PVDF powder.

### Stitching of Preforms for RTM Composite Panels

A PVDF monofilament stitch was selected for its demonstrated solution compatibility at temperature with epoxy resins, and in particular with Hexcel RTM6 epoxy resin. Four plies of Saertex 930 gsm biaxial NCF, with reinforcing fibres in 0° and 90° orientations, were arranged in a preferred orientation and position. A filament of PVDF, 0.48 mm in diameter, was stitched by hand through the fabric stack. Knotted stitches in lines across the fabric stack were completed at 50 mm intervals. The stitching fixed the relative position of the individual fabric plies relative to each other, allowing the fabric stack to be handled as a single unit or preform. The mould was closed and infused with Hexcel RTM6 resin at 80° C., and cured at 177° C. for 2 hours. The stitches were still visible on the surface of the panel, with surfaces wet well by epoxy. Tests conducted on an equivalent panel, where 0.94 mm diameter PVDF thread was placed on top of a fabric stack prior to identical infusion and cure with RTM6. Using a sturdy knife, it was not possible to remove the thread from its surrounding resin.

1. A process for manufacturing a reinforcing fibre preform or fabric including a thermoplastic polymer binder, for subsequent infusion with uncured thermosetting polymer and curing to make a high-performance thermoset polymer composite structure, the process including:
selecting a semi-crystalline thermoplastic polymer as a binder for the fabric or preform and a thermosetting polymer or class of thermosetting polymers for the thermosetting matrix of the thermoset polymer composite structure, such that said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer;
applying said semi-crystalline thermoplastic binder polymer discretely to selected regions of reinforcing fibre material;
bringing together and aligning said reinforcing fibre material and said semi-crystalline thermoplastic binder polymer into the desired spatial arrangement, shape and proximity;
heating said reinforcing fibre material and said semi-crystalline thermoplastic binder polymer to a temperature whereby said semi-crystalline thermoplastic polymer is able to flow and wet the fibres;
cooling said reinforcing fibre material and said semi-crystalline thermoplastic polymer below the flow temperature of said semi-crystalline thermoplastic polymer, thereby fixing said reinforcing fibre material into position and orientation through adhesion between said thermoplastic polymer and said reinforcing fibre material.

2. A process for manufacturing a reinforcing fibre preform or fabric including a thermoplastic polymer binder, for subsequent infusion with uncured thermosetting polymer and curing to make a high-performance thermoset polymer composite structure, the process including:
selecting a semi-crystalline thermoplastic polymer as a binder for the fabric or preform and a thermosetting polymer or class of thermosetting polymers for the thermosetting matrix of the thermoset polymer composite structure, such that said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer;
bringing together and aligning the reinforcing fibre material into the desired spatial arrangement, shape and proximity;
fixing said reinforcing fibre material in position and orientation using said semi-crystalline thermoplastic polymer in the form of one or more fibres, filaments, threads, or yarns, by combining said reinforcing fibre material and said thermoplastic binder by a textile process selected from the group consisting of stitching, weaving, tufting, braiding, weft knitting and warp knitting.

3. The process of claim 1 or 2, where said semi-crystalline thermoplastic polymer and said uncured thermosetting polymer components at or below the curing temperature of said thermosetting polymer have Hansen solubility parameters indicative of the ability of the thermoplastic polymer and thermosetting polymer components to interpenetrate and form a semi-interpenetrating polymer network.

4. The process of claim 1 or 2, where the solution compatibility of the thermoplastic binder and the uncured thermosetting polymer is such that the semi-interpenetrating polymer network which may be formed at the interface between the two polymers during curing of the thermosetting matrix has a thickness of between 0.1 and 100 μm.

5. The process of claim 1 or 2, where the solution compatibility of the thermoplastic binder and the uncured thermosetting polymer is such that the semi-interpenetrating polymer network which may be formed at the interface between the two polymers during curing of the thermosetting matrix has a thickness of between 1 and 10 μm.

6. A process according to claims 1 or 2, wherein the curing temperature of the thermosetting polymer is above the melting temperature of the semi-crystalline thermoplastic polymer.

7. A process according to claim 1 or 2, wherein the semicrystalline thermoplastic binder polymer is polyvinylidene fluoride (PVDF) or a polymer containing PVDF in any sort of combination with other polymers or additives, or a copolymer containing PVDF blocks or monomer units.

8. A process according to claim 1 or 2, wherein the thermoplastic polymer binder is in the form of a filament, a multifilament thread, a woven or non-woven veil, a web, a perforated sheet, small particles or a powder.

9. A process according to claim 1 or 2, wherein the thermosetting matrix polymer is an epoxy or bismaleimide.

10. A process according to claims 1 or 2, wherein the reinforcing fabric is infused with uncured thermosetting resin to make a pre-impregnated fabric, for later lay-up on a mould and full curing.

11. A process according to claim 1 or 2, wherein the semicrystalline thermoplastic binder polymer is polyamide, or a polymer containing polyamide in combination with other polymers or additives, or a copolymer containing polyamide blocks or monomer units.

12. A fibre-reinforcing fabric or preform, including reinforcing fibres and semicrystalline thermoplastic polymer binder, for subsequent infusion with uncured thermosetting polymer, or a class of thermosetting polymers, and curing to make a high-performance thermoset polymer composite structure, where said semi-crystalline thermoplastic polymer and said thermosetting polymer or components of said thermosetting polymer have a high level of solution compatibility at the curing temperature of the thermosetting polymer and are able to partially interpenetrate before curing of the thermosetting polymer.

13. The fibre-reinforcing fabric or preform of claim 12, where the solution compatibility of the semi-crystalline thermoplastic polymer binder and the uncured thermosetting polymer is such that the semi-interpenetrating polymer network which may be formed at the interface between the two polymers during curing of the thermosetting matrix has a thickness of between 0.1 and 100 μm.

14. The fibre-reinforcing fabric or preform of claim 12, where the solution compatibility of the semi-crystalline thermoplastic polymer binder and the uncured thermosetting polymer is such that the semi-interpenetrating polymer network which may be formed at the interface between the two polymers during curing of the thermosetting matrix has a thickness of between 1 and 10 μm.

15. The fibre-reinforcing fabric or preform of claim 12, where the semi-crystalline thermoplastic binder is polyvinylidene fluoride (PVDF) or a polymer containing PVDF in any sort of combination with other polymers or additives, or a copolymer containing PVDF blocks or monomer units.

16. The fibre-reinforcing fabric or preform of claim 12, where the thermoplastic polymer binder is in the form of a filament, a multifilament thread, a woven or non-woven veil, a web, a perforated sheet, small particles or a powder.

17. A fibre-reinforcing fabric according to claim 12, where the reinforcing fabric is infused with uncured thermosetting resin to make a pre-impregnated fabric, for later lay-up on a mould and full curing.

18. A reinforced thermoset polymer composite structure including reinforcing fibre material and a thermoset matrix polymer, at least part of the reinforcing fibre material having previously been assembled into a fabric or preform using a semicrystalline thermoplastic binder polymer, the thermoplastic binder polymer and the cured thermoset matrix polymer having an interfacial region with a semi-interpenetrating polymer network structure.

19. The reinforced thermoset polymer composite structure of claim 18, where the semi-interpenetrating polymer network structure formed at the interfacial region has a thickness of between 0.1 and 100 μm.

20. The reinforced thermoset polymer composite structure of claim 18, where the semi-interpenetrating polymer network structure formed at the interfacial region has a thickness of between 1 and 10 μm.

21. The reinforced thermoset polymer composite structure of claim 18, where the semicrystalline thermoplastic binder polymer is polyvinylidene fluoride (PVDF) or a polymer containing PVDF in any sort of combination with other polymers or additives, or a copolymer containing PVDF blocks or monomer units.

22. The reinforced thermoset polymer composite structure of claim 18, where the thermosetting matrix polymer is an epoxy or bismaleimide.

23. A process for manufacturing a fibre reinforced thermoset composite, wherein a reinforced fibre preform or fabric manufactured by the process according to claim 1 or 2, having a thermoplastic binder, is combined with an uncured thermosetting polymer selected according to the criteria in claim 1 or 2, the process including:
placing the preform or fabric onto or within a tool suitable for infusion of an uncured thermosetting polymer, and enclosing said preform or fabric such that an enclosed cavity is formed;
transferring said uncured thermosetting polymer into said cavity, such that the uncured thermosetting polymer is in intimate contact with said reinforcing fibres and thermoplastic binder;
raising the temperature of the combined materials such that the uncured thermosetting polymer and thermoplastic binder are able to partly interpenetrate prior to curing of the thermosetting polymer;
maintaining the combined materials at an elevated temperature for such time as required to effect the cure of the thermosetting polymer, wherein the curing temperature of the thermosetting resin is greater than or equal to the temperature at which the thermosetting polymer and the thermoplastic polymer binder are able to partially interpenetrate before curing of the thermosetting polymer;
cooling said combined materials.
